(19) United States
(12) Patent Application Publication
(10) Pub. No.: US 2017/0015567 A1
(43) Pub. Date: Jan. 19, 2017

(54) OIL-WATER SEPARATION TREATMENT SYSTEM AND OIL-WATER SEPARATION TREATMENT METHOD

(71) Applicant: SUMITOMO ELECTRIC INDUSTRIES, LTD., Osaka-shi, Osaka (JP)

(72) Inventor: Hideki KASHIHARA, Osaka (JP)

(21) Appl. No.: 15/124,128

(22) PCT Filed: Mar. 24, 2015
(86) PCT No.: PCT/JP2015/058884

§ 371 Date: Sep. 7, 2016

(30) Foreign Application Priority Data
Apr. 11, 2014 (JP) 2014-082367

(51) Int. Cl. C02F 1/40; C02F 1/44; C02F 1/24; C02F 1/28

(52) U.S. Cl. CPC C02F 1/40; C02F 1/285; C02F 1/288; C02F 1/286; C02F 1/44; C02F 1/24; C02F 2101/32

(57) ABSTRACT

An oil-water separation treatment system according to an embodiment of the present invention is an oil-water separation treatment system that separates a water-insoluble oil component from an oil-water mixed liquid, the system including an adsorption tower unit including at least one adsorption tower module, and a filtration unit including at least one filtration membrane module in that order. The adsorption tower module includes a tubular main body disposed vertically or horizontally, and a plurality of treatment layers which are divided from each other along an axial direction of the main body and in which a plurality of particles are enclosed. The filtration membrane module includes a filtration tank, a plurality of hollow fiber membranes that are disposed in the filtration tank and held in a state of being arranged to extend in one direction, and a holding member that fixes both ends of the plural hollow fiber membranes.

### TECHNICAL FIELD

The present invention relates to an oil-water separation treatment system and an oil-water separation treatment method.

### BACKGROUND ART

From the viewpoint of environmental conservation, oil-water mixed liquids (produced water) containing oil and suspended substances and generated in oilfields or the like need to be disposed of after the amounts of the oil and suspended substances mixed are reduced to certain values or less. Examples of the method for separating and removing oil and suspended substances from an oil-water mixed liquid include weight difference separation, distillation separation, and chemical separation. An example of the method for separating and removing oil and suspended substances at a low cost is a method using a water treatment layer filled with particles.

A treatment apparatus using the water treatment layer is an apparatus that separates oil and suspended substances in an oil-water mixed liquid by using particles and that discharges water from which the oil and suspended substances have been removed (refer to Japanese Unexamined Patent Application Publication No. 5-154309).

### CITATION LIST

### Patent Literature

PTL 1: Japanese Unexamined Patent Application Publication No. 5-154309

### SUMMARY OF INVENTION

### Technical Problem

The treatment apparatus including the existing water treatment layer can be suitably used for an oil-water mixed liquid that contains particles of impurities such as oil having a size in a certain range. However, since the treatment apparatus includes only a single treatment layer, in a case of an oil-water mixed liquid that further contains, for example, suspended substances having various sizes and an emulsion of oil, it is necessary to repeat a treatment a plurality of times in multiple stages, and thus an increase in the size of the apparatus is inevitable. Furthermore, fine oil droplets and the like may not be sufficiently removed by using this treatment layer alone.

The present invention has been made in view of the circumstances described above. An object of the present invention is to provide an oil-water separation treatment system and an oil-water separation treatment method that can efficiently treat an oil-water mixed liquid containing oil droplets and suspended substances that have various particle diameters in a saved space. The present invention can be suitably used for oilfield produced water generated in an oilfield or the like. The application of the present invention is not limited to such oilfield produced water. The present invention can be widely applied to an oil-removing purification treatment of wastewater containing oil from a factory or the like.

### Solution to Problem

An oil-water separation treatment system according to an embodiment of the present invention that has been made in order to solve the above problems is an oil-water separation treatment system that separates a water-insoluble oil component from an oil-water mixed liquid, the system including an adsorption tower unit including at least one adsorption tower module, and a filtration unit including at least one filtration membrane module in that order. The adsorption tower module includes a tubular main body disposed vertically or horizontally, and a plurality of treatment layers which are divided from each other along an axial direction of the main body and in which a plurality of particles are enclosed. The filtration membrane module includes a filtration tank, a plurality of hollow fiber membranes that are disposed in the filtration tank and held in a state of being arranged to extend in one direction, and a holding member that fixes both ends of the plural hollow fiber membranes.

An oil-water separation treatment method according to an embodiment of another invention that has been made in order to solve the above problems is an oil-water separation treatment method for separating a water-insoluble oil component from an oil-water mixed liquid, the method including a step of performing an adsorption treatment of an oil-water mixed liquid, the step being performed by an adsorption tower unit including at least one adsorption tower module, and a filtration treatment step performed by a filtration unit including at least one filtration membrane module in that order. In the method, the adsorption tower module includes a tubular main body disposed vertically or horizontally, and a plurality of treatment layers which are divided from each other along an axial direction of the main body and in which a plurality of particles are enclosed, and the filtration membrane module includes a filtration tank, a plurality of hollow fiber membranes that are disposed in the filtration tank and held in a state of being arranged to extend in one direction, and a holding member that fixes both ends of the plural hollow fiber membranes.

### Advantageous Effects of Invention

The oil-water separation treatment system and the oil-water separation treatment method of the present invention can efficiently treat an oil-water mixed liquid containing oil droplets and suspended substances that have various particle diameters in a saved space. Therefore, according to the oil-water separation treatment system and the oil-water separation treatment method of the present invention, a separation treatment of an oil-water mixed liquid that contains various suspended substances in addition to oil can be performed in a large amount.

### BRIEF DESCRIPTION OF DRAWINGS

FIG. 1 is a schematic conceptual diagram illustrating a water treatment system according to an embodiment of the present invention.

FIG. 2 is a schematic end view illustrating an embodiment of an adsorption tower unit in FIG. 1.

FIG. 3 is a schematic end view illustrating a filtration unit in FIG. 1.

FIG. 4 is a schematic cross-sectional view illustrating a hollow fiber membrane of a filtration membrane module included in the filtration unit in FIG. 3.

FIG. 5 is a schematic end view illustrating an embodiment of an adsorption tower unit in FIG. 1, the embodiment being different from that illustrated in FIG. 2.

### REFERENCE SIGNS LIST

1, 201 adsorption tower module

2 main body

3 first treatment layer

3a first particle

4 second treatment layer

4a second particle

5 adsorption agent layer

6 first partition plate

7 second partition plate

8 third partition plate

9 first space portion

10 second space portion

11 header portion

12 supply tube

13 collection tube

14 discharge tube

15 jet water flow-feeding tube

21 first treatment layer

21a first particle

21b first space

22 second treatment layer

22a second particle

22b second space

23 third treatment layer

23a third particle

23b third space

24 first gap layer

25 second gap layer

31 first partition plate

31a first wall portion

32 second partition plate

32a second wall portion

33 third partition plate

33a third wall portion

34 fourth partition plate

34a fourth wall portion

35 fifth partition plate

35a fifth wall portion

36 sixth partition plate

41 supply tube

41a partition plate

42 collection tube

50 partition plate

50a wall portion

51 connecting portion

51a wall portion

70 filtration membrane module

71 filtration tank

72 hollow fiber membrane

72a supporting layer

72b filtration layer

73 upper holding member

74 lower holding member

74a outer frame

74b fixing part

75 gas supplier

76 discharge tube

100 separator

200 adsorption tower unit

300 filtration unit

X produced water

Y untreated liquid

Z filtered liquid

A jet water flow

B cleaning fluid

C bubble

### DESCRIPTION OF EMBODIMENTS

### Description of Embodiments of the Present Invention

An oil-water separation treatment system according to an embodiment of the present invention is an oil-water separation treatment system that separates a water-insoluble oil component from an oil-water mixed liquid, the system including an adsorption tower unit including at least one adsorption tower module, and a filtration unit including at least one filtration membrane module in that order. The adsorption tower module includes a tubular main body disposed vertically or horizontally, and a plurality of treatment layers which are divided from each other along an axial direction of the main body and in which a plurality of particles are enclosed. The filtration membrane module includes a filtration tank, a plurality of hollow fiber membranes that are disposed in the filtration tank and held in a state of being arranged to extend in one direction, and a holding member that fixes both ends of the plural hollow fiber membranes.

The oil-water separation treatment system includes an adsorption tower module including a plurality of treatment layers which are divided from each other along an axial direction of a tubular main body and in which a plurality of particles are enclosed. Therefore, the oil-water separation treatment system can efficiently treat an oil-water mixed liquid containing oil and various suspended substances in a stepwise manner, and effectively remove, in particular, relatively large oil components and suspended substances. In addition, since the adsorption tower module includes a plurality of treatment layers, the size of the apparatus can be reduced. The oil-water separation treatment system includes a filtration membrane module that further treats an untreated liquid discharged from the adsorption tower module. Therefore, finer oil and suspended substances can be separated efficiently. As a result, the oil-water separation treatment system can exhibit a high water treatment efficiency in a saved space.

The adsorption tower module preferably includes, from the upstream side, a first treatment layer in which a plurality of first particles are enclosed, and a second treatment layer in which a plurality of second particles having an average diameter smaller than that of the first particles are enclosed.

The average diameter of the first particles is preferably 100 μm or more and 2,000 μm or less. The average diameter of the second particles is preferably 10 μm or more and 500 μm or less. When the adsorption tower module has such a configuration and the first particles and the second particles respectively have average diameters in the above ranges, the adsorption tower module can separate oil droplets and suspended substances that have relatively large particle diameters in the first treatment layer and then separate emulsified oil droplets and fine suspended substances in the second treatment layer. With this structure, an oil-water mixed liquid containing oil and various suspended substances can be treated without combining a plurality of water treatment apparatuses, and thus the size of the oil-water separation treatment system can be further reduced. The term “average diameter of particles” refers to a value determined by sequentially sieving particles through the sieves specified in JIS-Z8801-1 (2006) in descending order of opening size, and calculating from the number of particles on each sieve and the opening of the sieve.

The hollow fiber membranes preferably each include a supporting layer containing polytetrafluoroethylene as a main component and a filtration layer disposed on a surface of the supporting layer and containing polytetrafluoroethylene as a main component. When the hollow fiber membranes each include a supporting layer that contains polytetrafluoroethylene (PTFE) as a main component and a filtration layer that also contains PTFE as a main component, the amount of bending is small even in the case where the hollow fiber membrane has a high aspect ratio. Accordingly, the mechanical strength of the filtration membrane module can be increased, and damage and the like of the surfaces of the hollow fiber membranes due to scrubbing with bubbles can be reduced. As a result, the filtration capacity and the surface cleaning efficiency of the filtration membrane module can be improved in a balanced manner, and the oil-water separation treatment system can maintain the filtration capacity at a high level compared with existing oil-water separation treatment systems.

The oil-water mixed liquid is preferably oilfield produced water. The amount of oil contained in oilfield produced water generated in an oil-drilling site or the like is about 2,000 ppm or less. The oil-water separation treatment system can be particularly suitably used in applications of separation of such oilfield produced water.

The oil-water separation treatment system preferably includes a control unit that cleans the adsorption tower module and the filtration membrane module. When such a control unit that cleans the adsorption tower module and the filtration membrane module is provided, the oil-water separation treatment system can easily and reliably maintain the treatment capacity of the adsorption tower module.

The filtration membrane module preferably further includes a bubble supplier that supplies a bubble from below the hollow fiber membranes. When the filtration membrane module further includes such a bubble supplier, the surfaces of the hollow fiber membranes can be cleaned efficiently, and the oil-water separation treatment system can exhibit a high treatment capacity at a low operating cost.

The oil-water separation treatment system preferably further includes a movable body on which the adsorption tower unit, the filtration unit, and the control unit are placed. When such a movable body is provided, the oil-water separation treatment system can be easily transported to an oilfield or the like, and the cost of transportation and installation of the oil-water separation treatment system can be reduced.

The oil-water separation treatment system preferably further includes a separator that separates an oil-water mixed liquid from a drilled fluid. When such a separator is provided, the oil-water separation treatment system can effectively collect oil, gas, and the like from a drilled fluid, and the oil-water separation efficiency can be further increased.

An oil-water separation treatment method according to an embodiment of another invention that has been made in order to solve the above problems is an oil-water separation treatment method for separating a water-insoluble oil component from an oil-water mixed liquid, the method including a step of performing an adsorption treatment of an oil-water mixed liquid, the step being performed by an adsorption tower unit including at least one adsorption tower module, and a filtration treatment step performed by a filtration unit including at least one filtration membrane module in that order. In the method, the adsorption tower module includes a tubular main body disposed vertically or horizontally, and a plurality of treatment layers which are divided from each other along an axial direction of the main body and in which a plurality of particles are enclosed, and the filtration membrane module includes a filtration tank, a plurality of hollow fiber membranes that are disposed in the filtration tank and held in a state of being arranged to extend in one direction, and a holding member that fixes both ends of the plural hollow fiber membranes.

The oil-water separation treatment method includes an adsorption tower module including a plurality of treatment layers which are divided from each other along an axial direction of a tubular main body and in which a plurality of particles are enclosed. Therefore, an oil-water mixed liquid containing oil and various suspended substances can be efficiently treated in a stepwise manner. The oil-water separation treatment method includes a filtration membrane module that further treats an untreated liquid discharged from the adsorption tower module. Therefore, finer oil and suspended substances can be separated efficiently. As a result, the oil-water separation treatment method can exhibit a high water treatment efficiency in a saved space.

### Details of Embodiments of the Present Invention

An oil-water separation treatment system and an oil-water separation treatment method according to embodiments of the present invention will now be described in detail.

### [Oil-Water Separation Treatment System]

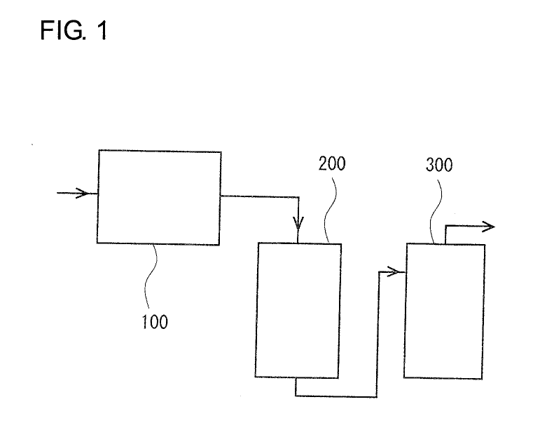

An oil-water separation treatment system illustrated in FIG. 1 mainly includes a separator 100, an adsorption tower unit 200, and a filtration unit 300 in that order.

The oil-water separation treatment system can suitably separate water-insoluble oil components from oilfield produced water containing oil and suspended substances. The suspended substances contain, for example, sand, particles formed of silica, calcium carbonate, and the like, an iron powder, microorganisms, and wood chips.

### <Separator>

The separator 100 is a device that separates a drilled fluid of an oilfield or the like into gas, oil, and produced water.

The separator 100 of the oil-water separation treatment system may be a known separator. For example, a separator that separates gas and liquid and an oil-water separator may be used in combination. A separator that separates a drilled fluid into gas, oil, and produced water at one time may be used.

### <Adsorption Tower Unit>

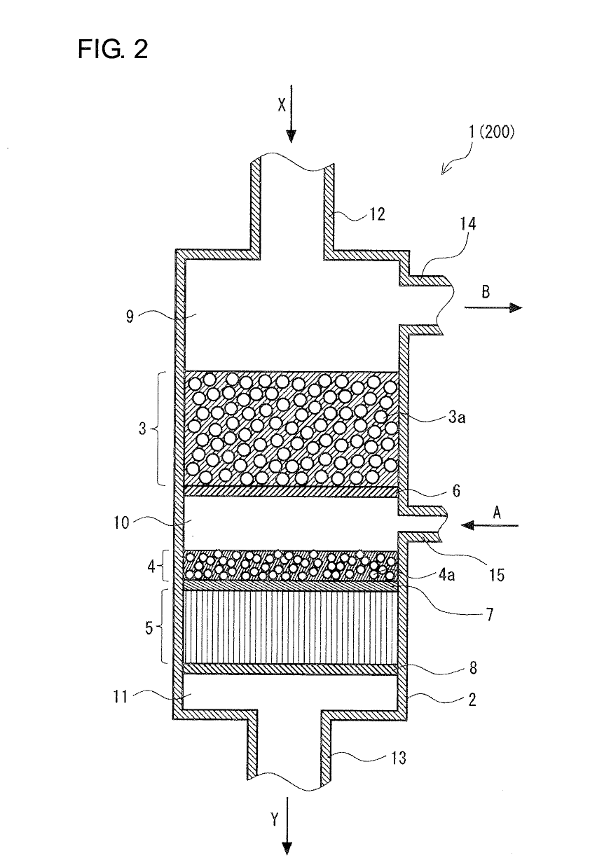

The adsorption tower unit 200 includes an adsorption tower module 1, as illustrated in FIG. 2. The adsorption tower module 1 includes a tubular main body 2 that is vertically disposed, and a plurality of treatment layers which are divided from each other along an axial direction of the main body 2 and in which a plurality of particles are enclosed. The treatment layers include, from the upstream side, a first treatment layer 3 in which a plurality of first particles 3a are enclosed, a second treatment layer 4 in which a plurality of second particles 4a having an average diameter smaller than that of the first particles 3a are enclosed, and an adsorption agent layer 5 in which an adsorption agent that adsorbs oil is enclosed. Furthermore, in a steady state, the adsorption tower module 1 includes a first space portion 9 on the first treatment layer 3, a second space portion 10 on the second treatment layer 4, and a header portion 11 under the adsorption agent layer 5. The adsorption tower module 1 purifies produced water X supplied from an upper portion thereof using the plural treatment layers provided in the main body 2 and collects an untreated liquid Y from a lower portion thereof.

The adsorption tower module 1 further includes a reverse cleaning water-supply portion (not shown) that supplies reverse cleaning water from a lower portion of the main body 2, a reverse cleaning water-collecting portion (not shown) that collects the reverse cleaning water from an upper portion of the main body 2, and a jet water flow-generating portion (not shown) that jets reverse cleaning water from a lateral side to the second space portion 10.

### (Main Body)

The main body 2 is a tubular body and is disposed such that a central axis thereof coincides or substantially coincides with the vertical direction. The main body 2 includes a supply tube 12 that is connected to an upper surface portion and that supplies the produced water X, a collection tube 13 that is connected to a bottom surface portion and that collects the untreated liquid Y, a discharge tube 14 which is connected to an upper portion of a side surface portion and from which a cleaning fluid B is discharged during reverse cleaning, and a jet water flow-feeding tube 15 that is connected to a side surface of the second space portion 10 described below and that supplies a jet water flow A.

The collection tube 13 is a tube that collects the untreated liquid Y, is connected to the reverse cleaning water-supply portion described below, and supplies reverse cleaning water to the inside of the main body 2 in a reverse cleaning state. The discharge tube 14 is a tube that is connected to the reverse cleaning water-collecting portion described below and discharges reverse cleaning water from the inside of the main body 2. The jet water flow-feeding tube 15 is a tube that is connected to the jet water flow-generating portion described below and supplies the jet water flow A to the inside of the main body 2 in the reverse cleaning state. Opening-closing mechanisms (not shown) such as valves are provided in the discharge tube 14 and the jet water flow-feeding tube 15 so that untreated water does not flow on the discharge tube 14 side and the jet water flow-feeding tube 15 side in the steady state.

The material of the main body 2 is not particularly limited. For example, a metal or a synthetic resin may be used. In particular, from the viewpoint of strength, heat resistance, chemical resistance, and so forth, a stainless steel, polypropylene, or an acrylonitrile-butadiene-styrene copolymer (ABS resin) is preferable. A fiber-reinforced plastic (FRP) reinforced with carbon fibers or glass fibers may be used.

The planar shape (bottom surface shape) of the main body 2 is not particularly limited and may be a circle, a rectangle, or the like. However, the planar shape of the main body 2 is preferably a circle. When the planar shape of the main body 2 is a circle, the main body 2 does not have corners therein. Therefore, clogging of particles and the like in corners can be prevented. This structure is also advantageous in that the strength of the main body 2 is easily designed.

The size of the main body 2 can be appropriately designed in accordance with the amount of produced water to be treated. The main body 2 may have a diameter of, for example, 0.5 m or more and 5 m or less. The main body 2 may have a height of, for example, 0.5 m or more and 10 m or less.

### (First Treatment Layer)

The first treatment layer 3 is disposed on the most upstream side of the inside of the main body 2, and a plurality of first particles 3a are enclosed in the first treatment layer 3. The plural first particles 3a are prevented from falling by a first partition plate 6 described below, and deposited on the upper surface side of the first partition plate 6 to form a layer. The first treatment layer 3 mainly removes oil droplets and suspended substance particles having relatively large particle diameters and contained in produced water.

Known particles for a filtration treatment can be used as the first particles 3a. For example, sand and particles containing, as a main component, a polymer compound, a natural material, or the like, the sand and the particles having a relatively large particle diameter, can be used.

Examples of the sand include anthracite, garnet, and manganese sand. These substances may be used alone or as a mixture of two or more thereof.

Examples of the polymer compound include vinyl resins, polyolefins, polyurethanes, epoxy resins, polyesters, polyamides, polyimides, melamine resins, and polycarbonates. Among these, vinyl resins, polyurethanes, and epoxy resins, all of which have good water resistance, oil resistance, and so forth, are preferable, and polyolefins, which have good adsorptivity, are more preferable. Furthermore, among polyolefins, polypropylene, which has particularly good oil adsorption capacity, is preferable. In the case of the polymer compound, crushed particles having irregular shapes are preferably used. By using crushed particles having irregular shapes, the particles can be densely deposited. Consequently, the filtration efficiency can be improved, and floating of the particles in the steady state can be prevented.

Natural materials whose particle sizes are adjusted by sieving may be used as the natural material. Examples thereof include walnut shells, sawdust, and natural fibers such as hemp.

Particles containing the above polymer compound as a main component are preferably used as the first particles 3a. By using, as the first particles 3a, particles containing a polymer compound as a main component, the cost and the weight of the adsorption tower module 1 can be reduced. In addition, since the specific gravity of the first particles 3a can be decreased, the stirring effect during reverse cleaning can be increased.

The lower limit of the average diameter of the first particles 3a is preferably 100 μm, more preferably 150 μm, and still more preferably 200 μm. The upper limit of the average diameter of the first particles 3a is preferably 2,000 μm, more preferably 1,000 μm, and still more preferably 500 μm. When the average diameter of the first particles 3a is less than the lower limit, the density of the particles enclosed in the first treatment layer 3 becomes high. Consequently, the pressure loss of the adsorption tower module 1 may increase, and the cost and the weight of the adsorption tower module 1 may increase. When the average diameter of the first particles 3a exceeds the upper limit, the performance of removing oil droplets and suspended substance particles having relatively large particle diameters may become insufficient.

The plural first particles 3a are deposited on the upper surface of the first partition plate 6 described below in the steady state (during the treatment of produced water). An average thickness of the deposited layer of the plural first particles 3a in the steady state is not particularly limited but is preferably equal to or less than an average height of the first space portion 9 described below in order to increase the stirring effect during reverse cleaning. The average thickness of the deposited layer of the plural first particles 3a in the steady state may be, for example, 10 cm or more and 1 m or less.

### (First Partition Plate)

The first partition plate 6 is a plate that is disposed between the first treatment layer 3 and the second treatment layer 4 and that prevents the first particles 3a from falling. That is, the first partition plate 6 has a configuration through which the first particles 3a do not pass but a liquid can pass. Specifically, the first partition plate 6 has a mesh (net) structure.

The material of the first partition plate 6 is not particularly limited. For example, a metal or a synthetic resin may be used. When a metal is used, a stainless steel (in particular, SUS 316L) is preferably used from the viewpoint of corrosion prevention. When a synthetic resin is used, a supporting member such as a reinforcing wire is preferably used in combination so that the opening is not changed by the water pressure and the weight of the particles.

The nominal opening of the mesh of the first partition plate 6 is designed so as to be equal to or less than the minimum diameter of the plural first particles 3a (the maximum opening of a sieve through which the first particles 3a do not pass). The nominal opening of the mesh of the first partition plate 6 is preferably smaller than the minimum diameter of the second particles 4a described below so that the second particles 4a do not enter the first treatment layer 3 during reverse cleaning. The upper limit of the nominal opening of the mesh of the first partition plate 6 is preferably 100 μm, and more preferably 80 μm. The lower limit of the nominal opening is preferably 10 μm, and more preferably 40 μm. When the nominal opening exceeds the upper limit, the first particles 3a or the second particles 4a may pass through the first partition plate 6. When the nominal opening is less than the lower limit, the pressure loss of the adsorption tower module 1 may increase, and the water treatment efficiency may become insufficient.

### (First Space Portion)

The first space portion 9 is a space that is formed on the first treatment layer 3 in the steady state and is disposed between the first treatment layer 3 and an upper surface of the main body 2. Some of oil and suspended substance particles separated in the first treatment layer 3 stay (are separated by floating) in the first space portion 9 and are discharged from the discharge tube 14 together with the cleaning fluid B during reverse cleaning. In addition, since the first particles 3a fly in the first space portion 9 and are stirred during reverse cleaning, reverse cleaning of the first treatment layer 3 can be effectively performed. The discharge tube 14 is connected to a lateral side of the first space portion 9. A portion (opening) of the discharge tube 14, the portion being connected to the first space portion 9, is preferably provided with a mesh member or the like having a nominal opening substantially the same as that of the first partition plate 6 so that the first particles 3a do not flow on the discharge tube 14 side.

An average height of the first space portion 9 in the steady state is not particularly limited but is preferably equal to or more than the average thickness of the deposited layer of the plural first particles 3a in order to increase the stirring effect during reverse cleaning. The average height of the first space portion 9 in the steady state may be, for example, 10 cm or more and 2 m or less.

The lower limit of a ratio of the average height of the first space portion 9 to the average thickness of the deposited layer of the plural first particles 3a in the steady state is preferably 1, and more preferably 2. The upper limit of the ratio is preferably 10. When the ratio is less than the lower limit, the effect of reverse cleaning of the first treatment layer 3 may not be sufficiently obtained. When the ratio exceeds the upper limit, the height of the adsorption tower module 1 may be unnecessarily large.

### (Second Treatment Layer)

The second treatment layer 4 is disposed on the downstream side of the first treatment layer 3, and a plurality of second particles 4a are enclosed in the second treatment layer 4. The plural second particles 4a are prevented from falling by a second partition plate 7 described below, and deposited on the upper surface side of the second partition plate 7 to form a layer. The second treatment layer 4 mainly removes oil droplets and suspended substances having medium to fine sizes and contained in produced water.

Known particles for a filtration treatment can be used as the second particles 4a. For example, sand and particles containing, as a main component, a polymer compound or the like, the sand and particles having a relatively small particle diameter, can be used. An example of the sand is diatomaceous earth. Examples of the polymer compound include vinyl resins, polyolefins, polyurethanes, epoxy resins, polyesters, polyamides, polyimides, melamine resins, and polycarbonates. Among these, vinyl resins, polyurethanes, and epoxy resins, all of which have good water resistance, oil resistance, and so forth, are preferable, and polyolefins, which have good adsorptivity, are more preferable. Furthermore, among polyolefins, polypropylene, which has particularly good oil adsorption capacity, is preferable. In the case of the polymer compound, crushed particles having irregular shapes are preferably used. By using crushed particles having irregular shapes, the particles can be densely deposited. Consequently, the filtration efficiency can be improved, and floating of the particles in the steady state can be prevented.

Particles containing the above polymer compound as a main component are preferably used as the second particles 4a. By using, as the second particles 4a, particles containing a polymer compound as a main component, the cost and the weight of the adsorption tower module 1 can be reduced. In addition, since the specific gravity of the second particles 4a can be decreased, the stirring effect during reverse cleaning can be increased.

The average diameter of the second particles 4a is smaller than the average diameter of the first particles 3a. The lower limit of the average diameter of the second particles 4a is preferably 10 μm, more preferably 30 and still more preferably 50 μm. The upper limit of the average diameter of the second particles 4a is preferably 500 μm, more preferably 300 μm, and still more preferably 100 μm. When the average diameter of the second particles 4a is less than the lower limit, the density of the particles enclosed in the second treatment layer 4 becomes high. Consequently, the pressure loss of the adsorption tower module 1 may increase, and the cost and the weight of the adsorption tower module 1 may increase. When the average diameter of the second particles 4a exceeds the upper limit, the performance of removing fine oil droplets and fine suspended substances may become insufficient. The uniformity coefficient of the second particles 4a may be the same as that of the first particles 3a.

The plural second particles 4a are deposited on the upper surface of the second partition plate 7 described below in the steady state (during the treatment of produced water). An average thickness of the deposited layer of the plural second particles 4a in the steady state is not particularly limited but is preferably equal to or less than an average height of the second space portion 10 described below in order to increase the stirring effect during reverse cleaning. The average thickness of the deposited layer of the plural second particles 4a in the steady state may be, for example, 1 cm or more and 50 cm or less.

### (Second Partition Plate)

The second partition plate 7 is a plate that is disposed between the second treatment layer 4 and the adsorption agent layer 5 and that prevents the second particles 4a from falling. That is, similarly to the first partition plate 6, the second partition plate 7 has a configuration through which the second particles 4a do not pass but a liquid can pass. Specifically, the second partition plate 7 has a mesh (net) structure.

The material of the second partition plate 7 may be the same as that of the first partition plate 6.

The nominal opening of the mesh of the second partition plate 7 is designed so as to be equal to or less than the minimum diameter of the second particles 4a (the maximum opening of a sieve through which the second particles 4a do not pass). The upper limit of the nominal opening of the mesh of the second partition plate 7 is preferably 80 μm, and more preferably 50 μm. The lower limit of the nominal opening is preferably 10 μm, and more preferably 20 μm. When the nominal opening exceeds the upper limit, the second particles 4a may pass through the second partition plate 7. When the nominal opening is less than the lower limit, the pressure loss of the adsorption tower module 1 may increase, and the water treatment efficiency may become insufficient.

### (Second Space Portion)

The second space portion 10 is a space that is formed on the second treatment layer 4 in the steady state and is disposed between the second treatment layer 4 and the first partition plate 6. Some of oil and suspended substance particles separated in the second treatment layer 4 stay (are separated by floating) in the second space portion 10, and, during reverse cleaning, passes through the first treatment layer 3 in a direction reverse to the direction in the steady state and are discharged from the discharge tube 14 together with the cleaning fluid B through the first space portion 9. In addition, since the second particles 4a fly in the second space portion 10 and are stirred during reverse cleaning, reverse cleaning of the second treatment layer 4 can be effectively performed. In this second space portion 10, particles such as the staying oil droplets grow, and the particle diameters thereof are increased. As a result, an effect of increasing the removal effect during reverse cleaning is also achieved. The jet water flow-feeding tube 15 is connected to a lateral side of the second space portion 10. A portion (opening) of the jet water flow-feeding tube 15, the portion being connected to the second space portion 10, is preferably provided with a mesh member or the like having a nominal opening substantially the same as that of the second partition plate 7 so that the second particles 4a do not flow on the jet water flow-feeding tube 15 side.

An average height of the second space portion 10 in the steady state is not particularly limited but is preferably equal to or more than the average thickness of the deposited layer of the plural second particles 4a in order to increase the stirring effect during reverse cleaning. The average height of the second space portion 10 in the steady state may be, for example, 2 cm or more and 1 m or less.

The lower limit of a ratio of the average height of the second space portion 10 to the average thickness of the deposited layer of the plural second particles 4a in the steady state is preferably 0.3, more preferably 1, and still more preferably 2. The upper limit of the ratio is preferably 10. When the ratio is less than the lower limit, the effect of reverse cleaning of the second treatment layer 4 may not be sufficiently obtained. When the ratio exceeds the upper limit, the height of the adsorption tower module 1 may be unnecessarily large.

The upper limit of the distance from the surface of the deposited layer of the plural second particles 4a to the center of the opening inside the main body 2 of the jet water flow-feeding tube 15 is preferably 0.8 times, and more preferably 0.6 times the average height of the second space portion 10 in the steady state. The lower limit of the distance is preferably 0.2 times, and more preferably 0.3 times the average height of the second space portion 10. When the distance is in the above range, the effect of stirring the second particles 4a by the jet water flow A can be significantly increased.

### (Adsorption Agent Layer)

The adsorption agent layer 5 is disposed on the downstream side of the second treatment layer 4. An adsorption agent that adsorbs oil is enclosed in the adsorption agent layer 5. This adsorption agent is prevented from falling by a third partition plate 8 described below, and fills between the third partition plate 8 and the second partition plate 7 to form a layer. This adsorption agent layer 5 mainly adsorbs and removes finer oil droplets that cannot be removed by the first treatment layer 3 and the second treatment layer 4.

Known adsorption agents for oil can be used as the adsorption agent. Examples thereof include porous ceramics, non-woven fabrics, woven fabrics, fibers, and activated carbon. Among these, non-woven fabrics formed of a plurality of organic fibers are preferable. Such a non-woven fabric formed of a plurality of organic fibers adsorbs oil with the organic fibers to separate oil and water. Therefore, in this non-woven fabric, the diameter of pores formed between the fibers need not be small, and the pores can have large diameters. Accordingly, clogging of the pores with high-viscosity oil is suppressed, and an increase in the pressure loss can be suppressed.

A main component of the organic fibers that form the non-woven fabric is not particularly limited as long as the main component is an organic resin that can adsorb oil. Examples thereof include cellulose resins, rayon resins, polyesters, polyurethanes, polyolefins (such as polyethylene and polypropylene), polyamides (such as aliphatic polyamides and aromatic polyamides), acrylic resins, polyacrylonitrile, polyvinyl alcohol, polyimides, silicone resins, and fluorocarbon resins. Among these, fluorocarbon resins or polyolefins are preferable. The use of organic fibers containing a fluorocarbon resin as a main component can increase heat resistance and chemical resistance of the non-woven fabric. Furthermore, among fluorocarbon resins, polytetrafluoroethylene, which has particularly good heat resistance and so forth is preferable. The use of organic fibers containing a polyolefin as a main component can increase oil adsorption capacity of the non-woven fabric. Furthermore, among polyolefins, polypropylene, which has particularly good oil adsorption capacity, is preferable. The material that forms the organic fibers may optionally contain, for example, other polymers, and additives such as a lubricant.

The upper limit of an average diameter of the organic fibers is preferably 1 more preferably 0.9 and still more preferably 0.1 μm. The lower limit of the average diameter of the organic fibers is preferably 10 nm. When the average diameter of the organic fibers exceeds the upper limit, the organic fibers have a small surface area per unit volume. Accordingly, it is necessary to increase the fiber density in order to ensure a certain oil adsorption capacity.

As a result, the pore diameter and the porosity of the non-woven fabric are reduced, and clogging with oil easily occurs. In particular, when the produced water X contains Bunker C, the particle diameter of the Bunker C dispersed and contained in water tends to become about 0.1 to 1.0 μm. Therefore, when the organic fibers have an average diameter of the above upper limit or less, the non-woven fabric can more reliably adsorb Bunker C. When the average diameter of the organic fibers is less than the lower limit, it may become difficult to form a non-woven fabric, and the strength of the non-woven fabric may be insufficient.

The lower limit of the porosity of the non-woven fabric is preferably 80%, more preferably 85%, and still more preferably 88%. The upper limit of the porosity of the non-woven fabric is preferably 99%, and more preferably 95%. When the porosity of the non-woven fabric is less than the lower limit, the amount of untreated liquid passed (the amount of untreated liquid treated) may decrease, and pores of the non-woven fabric are easily clogged with oil. When the porosity of the non-woven fabric exceeds the upper limit, the strength of the non-woven fabric may not be maintained.

The lower limit of an average pore diameter of the non-woven fabric is preferably 1 μm, more preferably 2 μm, and still more preferably 5 μm. The upper limit of the average pore diameter of the non-woven fabric is preferably 20 μm, and more preferably 8 μm. When the average pore diameter of the non-woven fabric is less than the lower limit, the amount of untreated liquid passed (the amount of untreated liquid treated) may decrease, and pores of the non-woven fabric are easily clogged with oil. When the average pore diameter of the non-woven fabric exceeds the upper limit, the oil adsorption function of the non-woven fabric may decrease, and the strength of the non-woven fabric may not be maintained.

The method for producing the non-woven fabric is not particularly limited, and known methods for producing a non-woven fabric can be used. Examples of the method include a method in which a fleece produced by a dry method, a wet method, spunbonding, meltblowing, or the like is bonded by spunlacing, thermal bonding, needle punching, chemical bonding, stitch bonding, needle punching, an air-through process, point bonding, or the like; and a method including forming a web by ejecting a fiber body having adhesiveness at a high speed by meltblowing. Among these bonding methods, the web-forming method by meltblowing, with which a non-woven fabric having a small fiber diameter can be formed relatively easily, is preferable.

The adsorption agent layer 5 may be formed by filling the inside of the main body 2 with a plurality of fibers. Long fibers having an average diameter of 1 μm or less are preferably used as the fibers.

An average thickness of the adsorption agent layer 5 can be appropriately designed in accordance with the type of adsorption agent and may be, for example, 1 cm or more and 1 m or less.

### (Third Partition Plate)

The third partition plate 8 is a plate that is disposed on the downstream side of the adsorption agent layer 5 and that prevents the adsorption agent from falling. That is, the third partition plate 8 has a configuration through which the adsorption agent does not pass but a liquid can pass. Specifically, the third partition plate 8 has a mesh (net) structure.

The material of the third partition plate 8 may be the same as that of the first partition plate 6. The nominal opening of the mesh of the third partition plate 8 may be a size that can prevent the adsorption agent from falling (flowing) and can be appropriately designed in accordance with the type of adsorption agent.

### (Header Portion)

The header portion 11 is a space formed below the adsorption agent layer 5, that is, between the third partition plate 8 and a bottom surface of the main body 2. The collection tube 13 that collects the untreated liquid Y is connected to a lower portion of the header portion 11. The untreated liquid Y that has passed through the first treatment layer 3, the second treatment layer 4, and the adsorption agent layer 5 is collected in the header portion 11 and then discharged to a filtration membrane unit 101 described below.

### (Reverse Cleaning Water-Supply Portion)

The reverse cleaning water-supply portion (not shown) supplies reverse cleaning water from a lower portion to an upper portion of the adsorption tower module 1 through the collection tube 13.

The reverse cleaning water-supply portion supplies reverse cleaning water by, for example, sending the untreated liquid Y or the like under pressure with a pump. The plural first particles 3a and second particles 4a fly upward and are stirred by an upward flow of the reverse cleaning water. Thus, oil droplets, suspended substances, and the like that have been captured between the particles are separated, and the separated oil droplets, suspended substances, and the like flow into an upper portion of the adsorption tower module 1. The oil droplets and suspended substances that flow into the upper portion are collected together with the cleaning fluid B in the reverse cleaning water-collecting portion described below through the discharge tube 14. For the purpose of collecting the reverse cleaning water of the second treatment layer 4 more smoothly, in addition to the discharge tube 14, another discharge tube may be provided in the vicinity of the jet water flow-feeding tube 15 of the second treatment layer 4 to collect the reverse cleaning water.

### (Jet Water Flow-Generating Portion)

The jet water flow-generating portion jets a jet water flow A (reverse cleaning water) toward the second space portion 10 through the jet water flow-feeding tube 15.

The jet water flow-generating portion jets the jet water flow A toward the second space portion 10. For example, a bubbling jet device, an eductor, or the like can be used as the jet water flow-generating portion.

The bubbling jet device is a device that includes a bubbling jet nozzle provided on the jet water flow-feeding tube 15 and that jets jet water by supplying gas and reverse cleaning water to the bubbling jet nozzle. For example, air can be used as the gas. Air outside the adsorption tower module 1 may be suctioned and used. In the jet water, the volume ratio of the gas to the reverse cleaning water is preferably high. The ratio of the volume of the gas to the volume of the reverse cleaning water is preferably, for example, 2 or more and 5 or less. An average diameter of bubbles formed by the gas is preferably 1 mm or more and 4 mm or less. The water-supply pressure of the reverse cleaning water is preferably 0.2 MPa or more. A flux of the jet water flow in a discharge opening of the bubbling jet nozzle is preferably 20 m/d or more.

The eductor is a device that draws peripheral water and that generates a strong water flow. An example of the device that can be used has a structure in which a suction opening is disposed in a throat portion between a nozzle that discharges jet water and a tube that supplies a fluid (reverse cleaning water) to the nozzle, and jet water is jetted from the nozzle by further suctioning the fluid from the suction opening by a flow of the fluid that passes through the throat portion.

The jet water flow A generated by the jet water flow-generating portion is jetted from the jet water flow-feeding tube 15 into the second space portion 10 from the lateral side. In addition to the upward flow of the reverse cleaning water supplied from the reverse cleaning water-supply portion, the jet water flow A from the lateral side stirs the second particles 4a more significantly. Thus, oil droplets, suspended substances, and the like that have been captured can be separated and removed more reliably.

The flow rate of the reverse cleaning water (the total flow rate of the reverse cleaning water-supply portion and the jet water flow-generating portion) may be, for example, double the amount of produced water supplied during filtration. The reverse cleaning time may be, for example, 30 seconds or more and 10 minutes or less. The reverse cleaning interval may be, for example, 1 hour or more and 12 hours or less.

### (Reverse Cleaning Water-Collecting Portion)

The reverse cleaning water-collecting portion (not shown) recovers, through the discharge tube 14, the cleaning fluid B containing oil droplets and suspended substances. This recovered reverse cleaning water can be supplied again, for example, as produced water X to the adsorption tower module 1.

### (Advantages of Adsorption Tower Module)

The adsorption tower module 1 can separate oil droplets and suspended substances that have relatively large particle diameters in the first treatment layer 3, and then separate emulsified oil droplets and fine suspended substances in the second treatment layer 4. Therefore, the adsorption tower module 1 can treat produced water containing oil and various suspended substances and, in particular, can effectively remove relatively large oil and suspended substances. In addition, since the adsorption tower module 1 includes a plurality of treatment layers, a reduction in the size of the apparatus can be realized. Accordingly, the adsorption tower unit 200 including the adsorption tower module 1 can treat produced water containing oil and various suspended substances and, in particular, can effectively remove relatively large oil and suspended substances.

### <Filtration Unit>

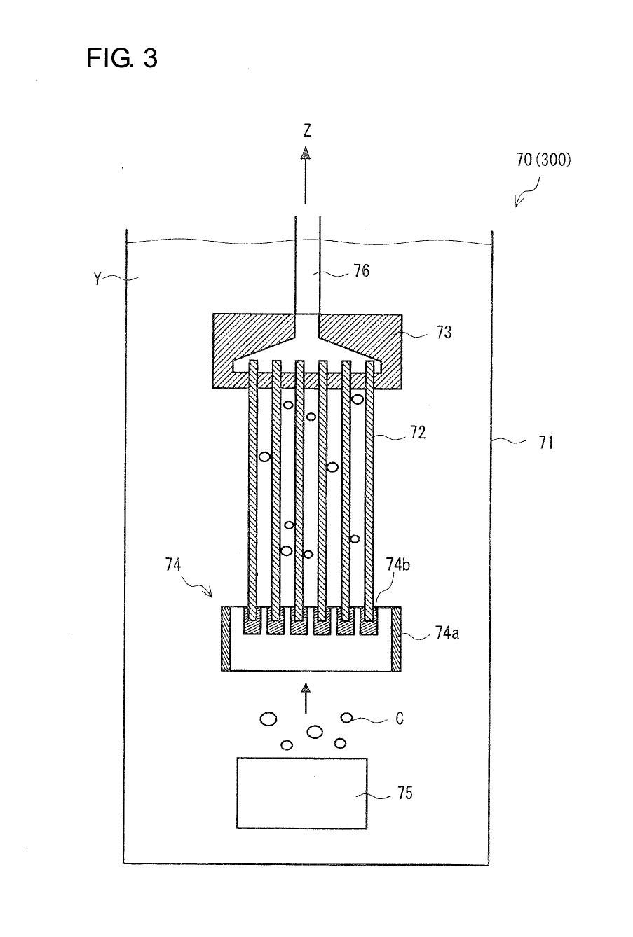

As illustrated in FIG. 3, the filtration unit 300 includes a filtration membrane module 70. The filtration membrane module 70 includes a filtration tank 71 that stores an untreated liquid Y, a plurality of hollow fiber membranes 72 that are immersed in the filtration tank 71 and held in a state of being arranged to extend in one direction, and holding members (an upper holding member 73 and a lower holding member 74) that fix both ends of the plural hollow fiber membranes 72. The filtration membrane module 70 further includes a bubble supplier 75 that supplies bubbles C from below the hollow fiber membranes 72. A discharge tube 76 is connected to a discharge portion of the upper holding member 73 of the filtration membrane module 70. A filtered liquid Z is discharged from the discharge tube 76.

### (Filtration Tank)

The filtration tank 71 is a container that can store a liquid therein. The filtration tank 71 is a tubular body.

The planer shape of the filtration tank 71 is not particularly limited and may be a circle, a polygon, or the like. The hollow fiber membranes 72 are disposed in the filtration tank 71 so that a direction in which the filtration membranes extend coincides with an axial direction of the filtration tank 71. Furthermore, an untreated liquid supply tube (not shown) that can supply an untreated liquid Y communicates through an upper portion of the filtration tank 71. The untreated liquid Y is supplied from the adsorption tower unit 200 to the filtration tank 71 through the untreated liquid supply tube. The untreated liquid Y supplied into the filtration tank 71 and filling the filtration tank 71 permeates through the hollow fiber membranes 72 as a result of, for example, driving of a suction pump (not shown) connected to the discharge tube 76, is subjected to solid-liquid separation, and is discharged as a filtered liquid Z through the discharge tube 76.

### (Hollow Fiber Membrane)

The hollow fiber membranes 72 are porous hollow fiber membranes that allow water to permeate into inner hollow portions thereof whereas prevent particles contained in the untreated liquid Y from permeating.

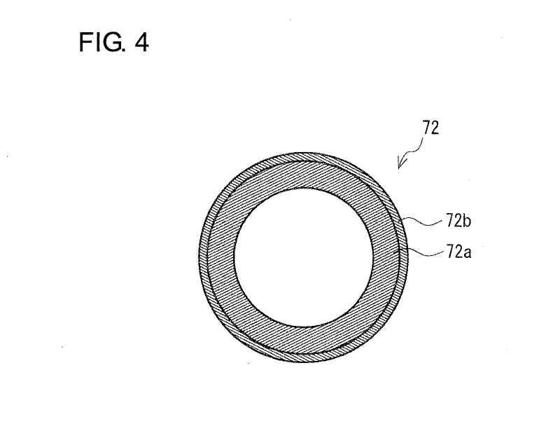

As illustrated in FIG. 4, each of the hollow fiber membranes 72 includes a cylindrical supporting layer 72a and a filtration layer 72b formed on the surface of the supporting layer 72a. Since the hollow fiber membrane 72 has such a multilayer structure, the water permeability and the mechanical strength are combined, and the surface cleaning effect obtained by the bubbles C can be increased.

The material that forms the supporting layer 72a and the filtration layer 72b preferably contains polytetrafluoroethylene (PTFE) as a main component. When the material that forms the supporting layer 72a and the filtration layer 72b contains PTFE as a main component, the hollow fiber membrane 72 has good mechanical strength, the amount of bending can be reduced even at a high aspect ratio, which is a ratio of an average length to an average outer diameter of the hollow fiber membrane, and damage or the like of the surface of the hollow fiber membrane due to scrubbing with the bubbles C does not easily occur. The material that forms the supporting layer 72a and the filtration layer 72b may optionally contain other polymers, additives, and so forth.

The lower limit of the number-average molecular weight of PTFE of the supporting layer 72a and the filtration layer 72b is preferably 500,000, and more preferably 2,000,000. The upper limit of the number-average molecular weight of PTFE of the supporting layer 72a and the filtration layer 72b is preferably 20,000,000. When the number-average molecular weight of PTFE is less than the lower limit, the surface of the hollow fiber membrane 72 may be damaged by scrubbing with the bubbles C, and the mechanical strength of the hollow fiber membrane 72 may decrease. When the number-average molecular weight of PTFE exceeds the upper limit, it may become difficult to form pores of the hollow fiber membrane 72.

For example, a tube obtained by extruding PTFE may be used as the supporting layer 72a. When an extruded tube is used as the supporting layer 72a, the mechanical strength can be provided to the supporting layer 72a, and pores can also be easily formed. This tube is preferably stretched at a stretching ratio of 50% or more and 700% or less in the axial direction and at a stretching ratio of 5% or more and 100% or less in the circumferential direction.

The temperature of the stretching is preferably equal to or lower than the melting point of the material of the tube, for example, about 0° C. to 300° C. In order to obtain a porous body having pores with relatively large diameters, stretching at a low temperature is preferable. In order to obtain a porous body having pores with relatively small diameters, stretching at a high temperature is preferable. The stretched porous body is heat-treated at a temperature of 200° C. or more and 300° C. or less for about 1 to 30 minutes while maintaining a stretched state in which both ends of the porous body are fixed. In such a case, a high dimensional stability is obtained. The size of the pores of the porous body can be controlled by combining conditions such as a stretching temperature and a stretching ratio.

The tube that forms the supporting layer 72a can be obtained by, for example, blending a liquid lubricant such as naphtha with a PTFE fine powder, forming a tube by, for example, extrusion molding of the resulting mixture, and subsequently stretching the tube. Furthermore, the dimensional stability can be increased by baking the tube by holding the tube in a heating furnace in which the temperature is maintained at a temperature equal to or more than the melting point of the PTFE fine powder, for example, about 350° C. to 550° C. for about several tens of seconds to several minutes.

The supporting layer 72a preferably has an average thickness of 0.1 mm or more. and 3 mm or less. When the supporting layer 72a has an average thickness in the above range, the mechanical strength and the water permeability can be provided to the hollow fiber membrane 72 in a balanced manner.

The filtration layer 72b can be formed by, for example, winding a PTFE sheet around the supporting layer 72a, and performing baking. The use of a sheet as the material that forms the filtration layer 72b can facilitate stretching, easily control the shape and the size of pores, and reduce the thickness of the filtration layer 72b. In addition, by winding a sheet and performing baking in this state, the supporting layer 72a and the filtration layer 72b are integrated, and pores of the supporting layer 72a and pores of the filtration layer 72b are interconnected to each other. Thus, the water permeability can be improved. This baking temperature is preferably equal to or more than the melting points of the tube that forms the supporting layer 72a and the sheet that forms the filtration layer 72b.

Examples of the method for preparing the sheet that forms the filtration layer 72b include (1) a method in which an unbaked molded body obtained by extruding a resin is stretched at a temperature equal to or less than the melting point thereof, and then baked, and (2) a method in which the a baked resin molded body is slowly cooled to increase the crystallinity, and then stretched. This sheet is preferably stretched at a stretching ratio of 50% or more and 1,000% or less in the longitudinal direction and at a stretching ratio of 50% or more and 2,500% or less in the short direction. In particular, in the case where the stretching ratio in the short direction is in the above range, the mechanical strength in the circumferential direction can be improved when the sheet is wound, and durability for surface cleaning with the bubbles C can be improved.

When the filtration layer 72b is formed by winding a sheet around a tube that forms the supporting layer 72a, fine irregularities are preferably provided on the outer circumferential surface of the tube. By providing irregularities on the outer circumferential surface of the tube, positional misalignment with the sheet can be prevented, and adhesiveness between the tube and the sheet can be improved to prevent the filtration layer 72b from separating from the supporting layer 72a during cleaning with the bubbles C. The number of times of winding the sheet can be adjusted in accordance with the thickness of the sheet, and may be one, or two or more. Alternatively, a plurality of sheets may be wound around the tube. The method for winding a sheet is not particularly limited. Besides a method in which a sheet is wound in the circumferential direction of a tube, a method in which a sheet is wound in a spiral manner may be employed.

The size (difference in height) of the fine irregularities is preferably 20 μm or more and 200 μm or less.

The fine irregularities are preferably formed over the entire outer circumferential surface of the tube. Alternatively, the fine irregularities may be formed partially or intermittently. Examples of the method for forming the fine irregularities on the outer circumferential surface of the tube include a flame treatment, laser irradiation, plasma irradiation, and coating with a dispersion of a fluorocarbon resin or the like. The flame treatment, with which irregularities can be easily formed without affecting properties of the tube, is preferable.

Alternatively, an unbaked tube and an unbaked sheet may be used. The unbaked sheet may be wound around the unbaked tube, and the resulting product may then be baked to enhance adhesiveness between the tube and the sheet.

The filtration layer 72b preferably has an average thickness of 5 μm or more and 100 μm or less. When the filtration layer 72b has an average thickness in this range, the hollow fiber membrane 72 can be easily and reliably provided with a high filtration performance.

The upper limit of an average outer diameter of the hollow fiber membranes 72 is preferably 6 mm, and more preferably 4 mm.

The lower limit of the average outer diameter of the hollow fiber membranes 72 is preferably 2 mm, and more preferably 2.1 mm. When the average outer diameter of the hollow fiber membranes 72 exceeds the upper limit, the ratio of the surface area to the cross section of each of the hollow fiber membranes 72 becomes small, and the filtration efficiency may decrease. In addition, the surface area on which a single bubble can scrub may decrease. When the average outer diameter of the hollow fiber membranes 72 is less than the lower limit, the mechanical strength of the hollow fiber membranes 72 may become insufficient.

The upper limit of an average inner diameter of the hollow fiber membranes 72 is preferably 4 mm, and more preferably 3 mm.

The lower limit of the average inner diameter of the hollow fiber membranes 72 is preferably 0.5 mm, and more preferably 0.9 mm. When the average inner diameter of the hollow fiber membranes 72 exceeds the upper limit, the thickness of each of the hollow fiber membranes 72 becomes small, and the mechanical strength and the effect of preventing impurities from permeating may become insufficient. When the average inner diameter of the hollow fiber membranes 72 is less than the lower limit, the pressure loss during discharging of the filtered liquid in the hollow fiber membranes 72 may increase.

The upper limit of a ratio of the average inner diameter to the average outer diameter of the hollow fiber membranes 72 is preferably 0.8, and more preferably 0.6. The lower limit of the ratio of the average inner diameter to the average outer diameter of the hollow fiber membranes 72 is preferably 0.3, and more preferably 0.4. When the ratio of the average inner diameter to the average outer diameter of the hollow fiber membranes 72 exceeds the upper limit, the thicknesses of the hollow fiber membranes 72 become small, and the mechanical strength and the effect of preventing impurities from permeating may become insufficient. When the ratio of the average inner diameter to the average outer diameter of the hollow fiber membranes 72 is less than the lower limit, the thicknesses of the hollow fiber membranes 72 become unnecessarily large, and the water permeability of the hollow fiber membranes 72 may decrease.

The lower limit of an average length of the hollow fiber membranes 72 is preferably 1 m, and more preferably 1.5 m.

The upper limit of the average length of the hollow fiber membranes 72 is preferably 6 m, and more preferably 5.5 m. When the average length of the hollow fiber membranes 72 is less than the lower limit, the surface area of each of the hollow fiber membranes 72 on which a single bubble C scrubs while the bubble C is supplied from a lower portion of the filtration membrane module 70 and rises to the water surface decreases, and the cleaning efficiency of the hollow fiber membranes 72 may decrease. In addition, swinging of the hollow fiber membranes 72 may not sufficiently occur. When the average length of the hollow fiber membranes 72 exceeds the upper limit, bending of the hollow fiber membranes 72 may be excessively increased by the weight of the hollow fiber membranes 72, and handleability in, for example, installing the filtration membrane module 70 may decrease. The term “average length of hollow fiber membranes 72” refers to an average distance from an upper end fixed to the upper holding member 73 to the lower end fixed to the lower holding member 74. As described below, when a hollow fiber membrane 72 is curved to have a U shape and the curved portion is fixed as a lower end to the lower holding member 74, the term “average length of hollow fiber membranes 72” refers to the average distance from this lower end to the upper end (opening).

The lower limit of the ratio (aspect ratio) of the average length to the average outer diameter of the hollow fiber membranes 72 is preferably 200, and more preferably 400. The upper limit of the aspect ratio of the hollow fiber membranes 72 is preferably 3,000, and more preferably 2,500. When the aspect ratio of the hollow fiber membranes 72 is less than the lower limit, the surface area of each of the hollow fiber membranes 72 on which a single bubble C can scrub decreases, and the cleaning efficiency of the hollow fiber membranes 72 may decrease. In addition, swinging of the hollow fiber membranes 72 may not sufficiently occur. When the aspect ratio of the hollow fiber membranes 72 exceeds the upper limit, the hollow fiber membranes 72 become extremely long and thin, and thus the mechanical strength when the hollow fiber membranes 72 are extended in an upward-downward direction may decrease.

The upper limit of the porosity of the hollow fiber membranes 72 is preferably 90%, and more preferably 85%. The lower limit of the porosity of the hollow fiber membranes 72 is preferably 75%, and more preferably 78%.

When the porosity of the hollow fiber membranes 72 exceeds the upper limit, the mechanical strength and scrubbing resistance of the hollow fiber membranes 72 may become insufficient. When the porosity of the hollow fiber membranes 72 is less than the lower limit, the water permeability may decrease, and the filtration capacity of the filtration membrane module 70 may decrease. The term “porosity” refers to a ratio of the total volume of pores to the volume of a hollow fiber membrane 72. The porosity can be determined by measuring the density of the hollow fiber membrane 72 in accordance with ASTM-D-792.

The upper limit of an area occupation ratio of pores of the hollow fiber membranes 72 is preferably 60%. The lower limit of the area occupation ratio of pores of the hollow fiber membranes 72 is preferably 40%. When the area occupation ratio of pores exceeds the upper limit, the surface strength of the hollow fiber membranes 72 may become insufficient, and, for example, breakage of the hollow fiber membranes 72 may be caused by scrubbing with the bubbles C. When the area occupation ratio of pores is less than the lower limit, the water permeability may decrease, and the filtration capacity of the filtration membrane module 70 may decrease. The term “area occupation ratio of pores” refers to a ratio of the total area of pores on the outer circumferential surface (filtration layer surface) of a hollow fiber membrane 72 to the surface area of the hollow fiber membrane 72. The area occupation ratio of pores can be determined by analyzing an electron microscopy image of the outer circumferential surface of the hollow fiber membrane 72.

The upper limit of an average diameter of pores of the hollow fiber membranes 72 is preferably 0.45 μm, and more preferably 0.1 μm. The lower limit of the average diameter of pores of the hollow fiber membranes 72 is preferably 0.01 μm. When the average diameter of pores of the hollow fiber membranes 72 exceeds the upper limit, impurities contained in the untreated liquid Y may not be prevented from permeating into the inside of the hollow fiber membranes 72. When the average diameter of pores of the hollow fiber membranes 72 is less than the lower limit, the water permeability may decrease. The term “average diameter of pores” refers to an average diameter of pores on the outer circumferential surface (filtration layer surface) of a hollow fiber membrane 72. The average diameter of pores can be measured with a pore size distribution measurement device (for example, “porous material automatic pore size distribution measurement system” available from Porus Materials Inc.).

The lower limit of a tensile strength of the hollow fiber membranes 72 is preferably 50 N, and more preferably 60 N. When the tensile strength of the hollow fiber membranes 72 is less than the lower limit, durability for surface cleaning with the bubbles C may decrease. The upper limit of the tensile strength of the hollow fiber membranes 72 is usually 150 N.

### (Upper Holding Member and Lower Holding Member)

The upper holding member 73 is a member that holds upper ends of the plural hollow fiber membranes 72. The upper holding member 73 communicates with upper openings of the plural hollow fiber membranes 72 and has a discharge portion (water collection header) that collects the filtered liquid Z. The discharge portion is connected to the discharge tube 76, which discharges the filtered liquid Z that has permeated into the inside of the plural hollow fiber membranes 72. The outer shape of the upper holding member 73 is not particularly limited, and the cross-sectional shape of the upper holding member 73 may be a polygon, a circle, or the like.

The lower holding member 74 is a member that holds lower ends of the plural hollow fiber membranes 72. As illustrated in FIG. 3, the lower holding member 74 includes an outer frame 74a, and a plurality of fixing parts 74b that fix the lower ends of the hollow fiber membranes 72. The plural fixing parts 74b are each formed so as to have, for example, a rod shape, and disposed in parallel or substantially in parallel at a certain interval. The plural hollow fiber membranes 72 are disposed on the upper side of the fixing parts 74b.

Regarding each of the hollow fiber membranes 72, both ends of a single hollow fiber membrane 72 may be fixed by the upper holding member 73 and the lower holding member 74. Alternatively, a single hollow fiber membrane 72 may be curved to have a U shape, the two openings may be fixed by the upper holding member 73, and the folded (curved) portion at the lower end may be fixed with the lower holding member 74.

The outer frame 74a is a member for supporting the fixing parts 74b. The length of a side of the outer frame 74a may be, for example, 50 mm or more and 200 mm or less. The cross-sectional shape of the outer frame 74a is not particularly limited, and may be a quadrangular shape, a polygonal shape other than a quadrangular shape, a circular shape, or the like.

The width (length in the short direction) of each of the fixing parts 74b and the interval of the fixing parts 74b are not particularly limited as long as the fixing parts 74b can fix a sufficient number of hollow fiber membranes 72 and can allow the bubbles C supplied from the gas supplier 75 to pass. The width of each of the fixing parts 74b may be, for example, 3 mm or more and 10 mm or less. The interval of the fixing parts 74b may be, for example, 1 mm or more and 10 mm or less.

The upper limit of a presence density (N/Aa) of the hollow fiber membranes 72, the presence density (N/Aa) being determined by dividing the number N of hollow fiber membranes 72 held by the lower holding member 74 by the area Aa of a region where the hollow fiber membranes 72 are disposed, is preferably 15/cm², and more preferably 12/cm². The lower limit of the presence density of the hollow fiber membranes 72 is preferably 4/cm², and more preferably 6/cm². When the presence density of the hollow fiber membranes 72 exceeds the upper limit, the interval of the hollow fiber membranes 72 becomes small and cleaning of the surfaces may not be sufficiently performed, and swinging of the hollow fiber membranes 72 may not sufficiently occur. When the presence density of the hollow fiber membranes 72 is less than the lower limit, the filtration efficiency per unit volume of the filtration membrane module 70 may decrease.

The upper limit of an area ratio (S/Aa) of the hollow fiber membranes 72, the area ratio (S/Aa) being determined by dividing the sum S of the cross sections of the hollow fiber membranes 72 held by the lower holding member 74 when the hollow fiber membranes 72 are assumed to be solid by the area Aa of a region where the hollow fiber membranes 72 are disposed, is preferably 60%, and more preferably 55%. The lower limit of the area ratio of the hollow fiber membranes 72 is preferably 20%, and more preferably 25%. When the area ratio of the hollow fiber membranes 72 exceeds the upper limit, the interval of the hollow fiber membranes 72 becomes small and cleaning of the surfaces may not be sufficiently performed. When the area ratio of the hollow fiber membranes 72 is less than the lower limit, the filtration efficiency per unit volume of the filtration membrane module 70 may decrease.

Examples of the material of the upper holding member 73 and the lower holding member 74 include, but are not particularly limited to, epoxy resins, ABS resins, and silicone resins.

The method for fixing the hollow fiber membranes 72 to the upper holding member 73 and the lower holding member 74 is not particularly limited. For example, a fixing method using an adhesive may be used.

In order to facilitate the handling (such as transportation, installation, and exchange) of the filtration membrane module 70, the upper holding member 73 and the lower holding member 74 are preferably connected to each other with a connecting member therebetween. For example, a metal supporting rod or a resin casing (outer cylinder) may be used as the connecting member.

### (Gas Supplier)

The gas supplier 75 supplies, from a lower portion of the filtration membrane module 70, bubbles C that clean the surfaces of the hollow fiber membranes 72. The bubbles C pass between the fixing parts 74b and rise while scrubbing the surfaces of the hollow fiber membranes 72, thereby cleaning the surfaces of the hollow fiber membranes 72.

The gas supplier 75 is immersed in the filtration tank 71 that stores the untreated liquid Y together with the filtration membrane module 70. The gas supplier 75 continuously or intermittently discharges gas supplied from a compressor or the like through a gas supply tube (not shown) to supply the bubbles C. The gas supplier 75 is not particularly limited, and a known air diffuser can be used. Examples of the air diffuser include air diffusers including a porous plate or porous tube obtained by forming a large number of pores in a plate or tube formed of a resin or ceramic; jet flow-type air diffusers that jet gas from a diffuser, a sparger, or the like; and intermittent bubble jet-type air diffusers that jet bubbles intermittently. An example of the intermittent bubble jet-type air diffuser is a pump that stores therein gas which is continuously supplied from a compressor or the like through a gas supply tube, and that intermittently discharges the gas when the gas is stored in a certain volume, thereby supplying bubbles. When large bubbles are intermittently jetted toward the hollow fiber membranes 72 by using such a pump, the bubbles are divided by the lower holding member 74 and rise while being in contact with the surfaces of the hollow fiber membranes 72. These divided bubbles have an average diameter close to the interval of the hollow fiber membranes 72 and easily disperse between the hollow fiber membranes 72 uniformly. Therefore, the bubbles effectively swing the plural hollow fiber membranes 72, and the cleaning efficiency of the hollow fiber membranes 72 can be further increased.

The gas supplied from the gas supplier 75 is not particularly limited as long as the gas is inert. From the viewpoint of the operating cost, air is preferably used.

### (Advantage of Filtration Membrane Module)

The filtration unit 300 including the filtration membrane module 70 performs filtration by using the plural hollow fiber membranes 72. Accordingly, relatively small oil and suspended substances remaining in the untreated liquid Y that has been treated by the adsorption tower unit 200 can be effectively removed.

### <Advantages of Oil-Water Separation Treatment System>

The oil-water separation treatment system includes the filtration unit 300 that further treats the untreated liquid Y discharged from the adsorption tower unit 200. Therefore, the oil-water separation treatment system can efficiently separate oil and suspended substances having various sizes. As a result, the oil-water separation treatment system can exhibit a high water treatment efficiency in a saved space. The oil-water separation treatment system can be widely applied not only to oilfield produced water but also to, for example, an oil-removing purification treatment of wastewater containing oil from a factory or the like. Furthermore, the oil-water separation treatment system can also be used as a water treatment system that separates and removes suspended substances, impurities, or water-insoluble oil components from untreated raw water.

### [Oil-Water Separation Treatment Method]

The oil-water separation treatment method includes an adsorption treatment step that is performed by the adsorption tower unit 200 illustrated in FIG. 1 and including the adsorption tower module in FIG. 2, and a filtration treatment step that is performed by the filtration unit 300 illustrated in FIG. 1 and including the filtration membrane module in FIG. 3 in that order.

In the adsorption treatment step, produced water X is suppled from an upper portion of the main body 2 of the adsorption tower module 1, and an untreated liquid Y is discharged from a lower portion of the main body 2. The method for supplying the produced water X is not particularly limited. An example of the method that can be used is a method in which the produced water X is sent to the adsorption tower module 1 under pressure with a pump or a hydraulic head.

In the filtration treatment step, the untreated liquid Y is supplied from the adsorption tower unit 200, and a filtered liquid Z after the treatment in the filtration tank 71 is discharged through the discharge tube 76.

The upper limit of a concentration of suspended substances in the untreated liquid Y in the oil-water separation treatment method is preferably 10 ppm, more preferably 5 ppm, still more preferably 3 ppm, and particularly preferably 1 ppm. When the concentration of suspended substances in the untreated liquid Y is the above upper limit or less, the separation treatment can be more efficiently performed with a spiral separation membrane module 101. The concentration of suspended substances means a concentration of suspended solids (SS) and is a value measured in accordance with “14.1 Suspended solids” described in JIS-K0102 (2008).

The upper limit of the concentration of suspended substances in the filtered liquid Z collected by the oil-water separation treatment method is preferably 1 ppm, more preferably 0.5 ppm, and particularly preferably 0.1 ppm. When the concentration of suspended substances in the filtered liquid Z is the above upper limit or less, the filtered liquid treated by the oil-water separation treatment method can be disposed of without applying a load to the environment and can be used as industrial water.

The upper limit of an oil concentration in the untreated liquid Y in the oil-water separation treatment method is preferably 100 ppm, more preferably 50 ppm, still more preferably 10 ppm, and particularly preferably 1 ppm. When the oil concentration in the untreated liquid Y is the above upper limit or less, oil-water separation can be more efficiently performed with the filtration unit 300.

The upper limit of the oil concentration in the filtered liquid Z collected by the oil-water separation treatment method is preferably 10 ppm, more preferably 5 ppm, still more preferably 1 ppm, and particularly preferably 0.1 ppm. When the oil concentration in the filtered liquid Z is the above upper limit or less, the load of an oil-water separation treatment performed after the oil-water separation treatment method can be reduced, and, under some conditions, even if another oil-water separation treatment is not performed, the filtered liquid that has been subjected to oil-water separation by the oil-water separation treatment method can be disposed of without applying a load to the environment.

### <Advantages of Oil-Water Separation Treatment Method>

The oil-water separation treatment method has a good purification treatment capacity of produced water containing oil and suspended substances and can efficiently treat produced water in a saved space. Furthermore, the oil-water separation treatment method can also perform a water treatment for separating and removing suspended substances, impurities, or water-insoluble oil components from untreated raw water.

### Other Embodiments

It is to be understood that the embodiments disclosed herein are only illustrative and are not restrictive in all respects. It is intended that the scope of the present invention be not limited to the configurations of the embodiments, but be determined by appended claims, and include all variations of the equivalent meanings and ranges to the claims.

The adsorption tower unit of the above embodiment includes a single adsorption tower module. Alternatively, the adsorption tower unit may include a plurality of adsorption tower modules connected in parallel. When such an adsorption tower unit is provided, the oil-water separation treatment system preferably further includes a control unit that performs reverse cleaning of the adsorption tower modules and the filtration membrane module. With this structure, the treatment capacity of the oil-water separation treatment system can be maintained easily and reliably. For example, by sequentially performing reverse cleaning of a single adsorption tower module or filtration membrane module with this control unit, the amount of treatment per unit time of the entire oil-water separation treatment system can be maintained constant. A plurality of modules may be stopped at the same time, and reverse cleaning may be performed for the stopped modules at the same time.

The filtration unit of the above embodiment includes a single filtration membrane module. Alternatively, the filtration unit may include a plurality of filtration membrane modules that are connected in series or parallel.

The oil-water separation treatment system may include a movable body on which the adsorption tower unit, the filtration unit, and the control unit are placed. For example, a container can be used as the movable body. The oil-water separation treatment system can be easily transferred and installed in any place by housing the units in the container and pulling the units in the container by a trailer or the like.

Furthermore, the direction in which the hollow fiber membranes in the filtration membrane module extend is not limited to the upward-downward direction. Alternatively, the direction may be a horizontal direction or an oblique direction. When the direction in which the hollow fiber membranes extend is not the upward-downward direction, the surfaces of the hollow fiber membranes may be scrubbed with bubbles by, for example jetting bubbles in the direction in which the hollow fiber membranes extend, or supplying bubbles while forming a water flow in a direction substantially the same as the direction in which the hollow fiber membranes extend.

The filtration membrane module includes a filtration tank that stores an untreated liquid, a plurality of hollow fiber membranes that are immersed in the filtration tank and held in a state of being arranged to extend in one direction, and holding members that fix both ends of the hollow fiber membranes. Alternatively, the filtration membrane module may have a structure in which a plurality of hollow fiber membranes, both ends of which are fixed by holding members, are disposed in a cylindrical filtration tank that can be hermetically sealed, and an untreated liquid is allowed to flow or subjected to cross-flow in the filtration tank so that filtration is performed from the outside to the inside of the hollow fiber membranes. Also in such a filtration membrane module, a gas supplier may be provided so that scrubbing is performed by supplying bubbles after reverse cleaning, and thus suspended substances can be removed from the surfaces of the hollow fiber membranes.

Furthermore, the adsorption tower module of the above embodiment includes the adsorption agent layer on the downstream side of the second treatment layer. However, when produced water has a small oil content, the adsorption agent layer may be omitted. When the adsorption tower module of the embodiment includes the adsorption agent layer, the third partition plate may be brought into contact with the bottom surface of the main body without providing the header portion. In this case, the third partition plate may be provided only in the opening portion of the collection tube. Furthermore, a filler layer that is similar to the second treatment layer may be provided as a third treatment layer. In such a case, an adsorption agent layer may be further provided. Furthermore, filler layers and adsorption agent layers may be provided in a plurality of stages. The configuration of the adsorption tower module is not limited to three stages.

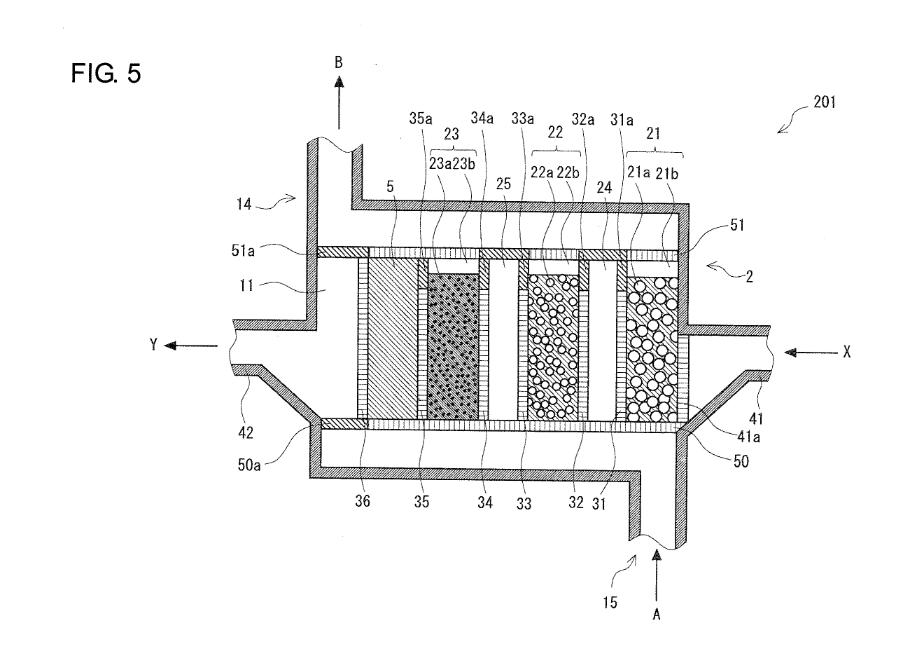

Alternatively, for example, as illustrated in FIG. 5, an adsorption tower module 201 disposed in a lateral direction may be used as the adsorption tower module. The adsorption tower module 201 disposed in a lateral direction will now be described. The configuration of the adsorption tower module 201 disposed in a lateral direction is also not limited to the four stages illustrated in FIG. 5. Various embodiments can be made as in the adsorption tower module of the embodiments described above.

The adsorption tower module 201 illustrated in FIG. 5 includes a tubular main body 2 that is horizontally disposed, and a plurality of treatment layers 21, 22, and 23 which are divided from each other along an axial direction of the main body 2 and in which a plurality of particles 21a, 22a, and 23a are enclosed, respectively. The adsorption tower module 201 supplies produced water X from one end side (the right side in the drawing) of the main body 2 in the axial direction and discharges an untreated liquid Y from the other end side (the left side in the drawing).

The plural treatment layers 21, 22, and 23 include, from the upstream side, a first treatment layer 21 in which a plurality of first particles 21 a are enclosed, a second treatment layer 22 in which a plurality of second particles 22a having an average diameter smaller than that of the first particles 21 a are enclosed, and a third treatment layer 23 in which a plurality of third particles 23a having an average diameter smaller than that of the second particles 22a are enclosed, in that order. An adsorption agent layer 5 in which an adsorption agent that adsorbs oil is enclosed is provided on the downstream side of the third treatment layer 23. The main body 2 further includes gap layers (a first gap layer 24 and a second gap layer 25) in which no particles are enclosed, the gap layers being disposed between the first treatment layer 21 and the second treatment layer 22 and between the second treatment layer 22 and the third treatment layer 23, respectively.

The main body 2 further includes a header portion 11. From the one end side on which the produced water X is supplied, the first treatment layer 21, the first gap layer 24, the second treatment layer 22, the second gap layer 25, the third treatment layer 23, the adsorption agent layer 5, and the header portion 11 are arranged in series in that order. These layers and the header portion 11 are partitioned by partition plates 31 to 36.

Elements the same as those of the adsorption tower module 1 according to the above embodiment are assigned the same reference numerals, and a description below is omitted.

(Treatment Layers in which a Plurality of Particles are Enclosed)

The plural treatment layers 21, 22, and 23 in which the plural particles 21a, 22a, and 23a are respectively enclosed are arranged in the order of the first treatment layer 21, the second treatment layer 22, and the third treatment layer 23 from the upstream side of the inside of the main body 2. The plural particles 21a, 22a, and 23a faun particle layers in the treatment layers 21, 22, and 23, respectively. For example, the first treatment layer 21 mainly removes oil droplets and suspended substance particles having relatively large particle diameters and contained in the produced water X. The second treatment layer 22 mainly removes oil droplets and suspended substance particles having medium particle diameters and contained in the produced water X. The third treatment layer 23 mainly removes fine oil droplets and fine suspended substances contained in the produced water X.

The length (width) of each of the plural treatment layers 21, 22, and 23 in the axial direction of the main body 2 is not particularly limited but may be, for example, 100 mm or more and 300 mm or less.

The lower limit of the average diameter of the first particles 21a is preferably 200 μm, more preferably 250 μm, and still more preferably 300 μm. The upper limit of the average diameter of the first particles 21a is preferably 500 μm, more preferably 450 μm, and still more preferably 400 μm.

When the average diameter of the first particles 21a is less than the lower limit, the density of the particles enclosed in the first treatment layer 21 becomes high, and the cost and the weight of the adsorption tower module 201 may increase.
When the average diameter of the first particles 21a exceeds the upper limit, the performance for removing oil droplets and suspended substance particles having relatively large particle diameters may become insufficient.

The average diameter of the second particles 22a is smaller than the average diameter of the first particles 21a. The lower limit of the average diameter of the second particles 22a is preferably 100 μm, more preferably 120 μm, and still more preferably 140 μm. The upper limit of the average diameter of the second particles 22a is preferably 300 μm, more preferably 250 μm, and still more preferably 200 μm. When the average diameter of the second particles 22a is less than the lower limit, the density of the particles enclosed in the second treatment layer 22 becomes high, and the cost and the weight of the adsorption tower module 201 may increase. When the average diameter of the second particles 22a exceeds the upper limit, the performance for removing fine oil droplets and fine suspended substances may become insufficient.

The average diameter of the third particles 23a is smaller than the average diameter of the second particles 22a. The lower limit of the average diameter of the third particles 23a is preferably 10 μm, more preferably 20 μm, and still more preferably 30 μm. The upper limit of the average diameter of the third particles 23a is preferably 100 μm, more preferably 80 μm, and still more preferably 60 μm. When the average diameter of the third particles 23a is less than the lower limit, the density of the particles enclosed in the third treatment layer 23 becomes high, and the cost and the weight of the adsorption tower module 201 may increase. When the average diameter of the third particles 23a exceeds the upper limit, the performance for removing fine oil droplets and fine suspended substances may become insufficient.

The uniformity coefficient of the plural particles 21a, 22a, and 23a may be the same as the uniformity coefficient of the first particles 3a and the second particles 4a of the adsorption tower module 1 according to the above embodiment.

Known particles for a filtration treatment can be used as the plural particles. Examples of the particles include sand and particles containing, as a main component, a polymer compound, a natural material, or the like.

The plural treatment layers 21, 22, and 23 include spaces 21b, 22b, and 23b (a first space 21b, a second space 22b, and a third space 23b) above the plural particles 21a, 22a, and 23a, respectively. Since the plural treatment layers 21, 22, and 23 include these spaces 21b, 22b, and 23b, respectively, during the cleaning of the treatment layers 21, 22, and 23, the plural particles 21a, 22a, and 23a fly in the spaces 21b, 22b, and 23b, respectively, and are stirred. Thus, the plural treatment layers 21, 22, and 23 can be cleaned effectively. Furthermore, some of oil and suspended substance particles separated in the plural treatment layers 21, 22, and 23 stay (are separated by floating) in the spaces 21b, 22b, and 23b, respectively, and are discharged together with a cleaning fluid B during the cleaning of the treatment layers 21, 22, and 23.

### (Gap Layers)

The two gap layers 24 and 25 are layers which are disposed between the first treatment layer 21 and the second treatment layer 22 and between the second treatment layer 22 and the third treatment layer 23, respectively, and in which no particles are enclosed. When the gap layers 24 and 25, in which no particles are enclosed, are respectively arranged between the first treatment layer 21 and the second treatment layer 22 and between the second treatment layer 22 and the third treatment layer 23, paths are formed through which a jet water flow A fed from lower portions during cleaning flows not only from lower portions of the treatment layers 21, 22, and 23 but also from lateral portions through the gap layers 24 and 25. Therefore, the plural particles 21a, 22a, and 23a are more significantly stirred, and oil droplets, suspended substances, and the like which have been captured can be more reliably separated and removed.

The length (width) of each of the gap layers 24 and 25 in the axial direction of the main body 100 is not particularly limited but may be, for example, 100 mm or more and 200 mm or less. A ratio of the width of each of the gap layers 24 and 25 to the width of each of the treatment layers 21, 22, and 23 (width of gap layer/width of treatment layer) may be, for example, 1/5 or more and 1 or less.

### (Supply Tube and Discharge Tube)

A supply tube 41 is connected to one end side of the main body 2 in the axial direction and supplies produced water X. A collection tube 42 is connected to the other end side of the main body 2 in the axial direction and discharges an untreated liquid Y. The main body 2 preferably includes a partition plate 41a (supply portion partition plate 41a) that prevents particles 21a (first particles 21a) of the first treatment layer 21 from flowing out, the partition plate 41a being disposed in a region connected to the supply tube 41. That is, the supply portion partition plate 41a has a configuration through which the first particles 21a do not pass but a liquid can pass. Specifically, the supply portion partition plate 41a has a mesh (net) structure.

### (Partition Plates)

The partition plates 31 to 36 are plates that are disposed between the treatment layers and that prevent the plural particles 21a, 22a, and 23a and the adsorption agent from flowing out. Similarly to the supply portion partition plate 41a, the partition plates 31 to 36 each have a mesh structure.

The material of the partition plates 31 to 36 and the partition plate 41a is not particularly limited, and a metal, a synthetic resin, or the like can be used. When a metal is used, from the viewpoint of corrosion prevention, a stainless steel (in particular, SUS 316L) is preferably used. When a synthetic resin is used, a supporting member such as a reinforcing wire is preferably used in combination so that the opening is not changed by the water pressure and the weight of the particles.

The nominal opening of the mesh of each of the supply portion partition plate 41a and the partition plate 31 (first partition plate 31) disposed between the gap layer 24 and the first treatment layer 21 is designed so as to be equal to or less than the minimum diameter of the plural first particles 21a (the maximum opening of a sieve through which the first particles 21a do not pass). The upper limit of the nominal opening of the mesh of the first partition plate 31 is preferably 200 μm, and more preferably 180 μm. The lower limit of the nominal opening is preferably 10 μm, and more preferably 80 μm. When the nominal opening exceeds the upper limit, the first particles 21a may pass through the supply portion partition plate 41a and the first partition plate 31. When the nominal opening is less than the lower limit, the flow velocity of the produced water X is excessively decreased by the pressure loss, and the treatment efficiency of the oil-water separation treatment system may become insufficient.

The nominal opening of the mesh of each of the partition plate 32 (second partition plate 32) disposed between the gap layer 24 and the second treatment layer 22 and the partition plate 33 (third partition plate 33) disposed between the second treatment layer 22 and the gap layer 25 is designed so as to be equal to or less than the minimum diameter of the plural second particles 22a (the maximum opening of a sieve through which the second particles 22a do not pass). The upper limit of the nominal opening of the mesh of each of the second partition plate 32 and the third partition plate 33 is preferably 100 μm, and more preferably 80 μm. The lower limit of the nominal opening is preferably 10 μm, and more preferably 40 μm. When the nominal opening exceeds the upper limit, the second particles 22a may pass through the second partition plate 32 and the third partition plate 33. When the nominal opening is less than the lower limit, the flow velocity of the produced water X is excessively decreased by the pressure loss, and the treatment efficiency of the oil-water separation treatment system may become insufficient.

The nominal opening of the mesh of the partition plate 34 (fourth partition plate 34) disposed between the gap layer 25 and the third treatment layer 23 is designed so as to be equal to or less than the minimum diameter of the plural third particles 23a (the maximum opening of a sieve through which the third particles 23a do not pass). The upper limit of the nominal opening of the mesh of the fourth partition plate 34 is preferably 80 μm, and more preferably 50 μm. The lower limit of the nominal opening is preferably 10 μm, and more preferably 20 μm. When the nominal opening exceeds the upper limit, the third particles 23a may pass through the fourth partition plate 34. When the nominal opening is less than the lower limit, the flow velocity of the untreated liquid is excessively decreased by the pressure loss, and the treatment efficiency of the oil-water separation treatment system may become insufficient.

The nominal opening of the mesh of each of the partition plate 35 (fifth partition plate 35) disposed between the third treatment layer 23 and the adsorption agent layer 5 and the partition plate 36 (sixth partition plate 36) disposed between the adsorption agent layer 5 and the header portion 11 has a size that can prevent the adsorption agent from flowing out. The nominal opening can be appropriately designed in accordance with the type of adsorption agent. It is also necessary that the fifth partition plate 35 prevent the third particles 23a from flowing out from the third treatment layer 23. Accordingly, the nominal opening of the mesh of the fifth partition plate 35 is preferably smaller than the nominal opening of the mesh of the fourth partition plate 34.

The first partition plate 31, the second partition plate 32, the third partition plate 33, the fourth partition plate 34, and the fifth partition plate 35 that contact the first treatment layer 21, the second treatment layer 22, and the third treatment layer 23 having the spaces 21b, 22b, and 23b, respectively, have, on upper portions thereof, wall portions 31a, 32a, 33a, 34a, and 35a (a first wall portion 31a, a second wall portion 32a, a third wall portion 33a, a fourth wall portion 34a, and a fifth wall portion 35a, respectively) that do not allow a fluid to permeate. The first wall portion 31a separates the first space 21b of the first treatment layer 21 from the adjacent first gap layer 24. Since the first wall portion 31a separates the first space 21b of the first treatment layer 21 from the adjacent first gap layer 24, it is possible to prevent the produced water X from passing through the first space 21b and flowing in the first gap layer 24. Similarly, regarding the second wall portion 32a, the third wall portion 33a, the fourth wall portion 34a, and the fifth wall portion 35a, it is possible to prevent the produced water X in each treatment layer from passing through a space in an upper portion of the treatment layer and flowing in an adjacent treatment layer.

(Jet Water Flow-Feeding Tube, Discharge Tube, and Partition Plate that Separates Main Body)

A jet water flow-feeding tube 15 is connected to a lower circumferential surface of the main body 2. The jet water flow-feeding tube 15 is disposed below the first treatment layer 21, the first gap layer 24, the second treatment layer 22, the second gap layer 25, the third treatment layer 23, the adsorption agent layer 5, and the header portion 11 of the main body 2 so as to extend over these. The jet water flow-feeding tube 15 is connected to the first treatment layer 21, the first gap layer 24, the second treatment layer 22, the second gap layer 25, the third treatment layer 23, the adsorption agent layer 5, and the header portion 11 with a partition plate 50 (jet water flow-feeding portion partition plate 50) therebetween.

The jet water flow-feeding portion partition plate 50 has a configuration through which the first particles 21a, the second particles 22a, the third particles 23a, and the adsorption agent do not pass but a liquid can pass. Specifically, the jet water flow-feeding portion partition plate 50 has a mesh structure. For example, the nominal opening of the mesh of the jet water flow-feeding portion partition plate 50 has a size that can prevent the smallest particle among the first particles 21a, the second particles 22a, the third particles 23a, and the adsorption agent from flowing out. The nominal opening can be appropriately designed in accordance with the types of particles. When the nominal opening of the mesh of the jet water flow-feeding portion partition plate 50 has a size that can prevent the smallest particle from flowing out, the mesh of the jet water flow-feeding portion partition plate 50 can prevent the first particles 21a, the second particles 22a, the third particles 23a, and the adsorption agent from falling in the jet water flow-feeding tube 15. The nominal opening of the mesh of the jet water flow-feeding portion partition plate 50 may be changed in each treatment layer to be connected as long as the first particles 21a, the second particles 22a, the third particles 23a, and the adsorption agent do not fall in the jet water flow-feeding tube 15.

The jet water flow-feeding portion partition plate 50 has a wall portion 50a in a region connected to the header portion 11. This wall portion 50a prevents the jet water flow A from passing through the header portion 11, in which particles and the like to be cleaned are not present, and being collected in the discharge tube 14, thus improving the cleaning efficiency. The wall portion 50a can also prevent the produced water X from flowing in the header portion 11 without being sufficiently filtered.

A discharge tube 14 is connected to an upper circumferential surface of the main body 2. The discharge tube 14 is disposed above the first treatment layer 21, the first gap layer 24, the second treatment layer 22, the second gap layer 25, the third treatment layer 23, the adsorption agent layer 5, and the header portion 11 of the main body 2 so as to extend over these. The discharge tube 14 is connected to the first treatment layer 21, the first gap layer 24, the second treatment layer 22, the second gap layer 25, the third treatment layer 23, the adsorption agent layer 5, and the header portion 11 with a connecting portion 51 therebetween.

The connecting portion 51 has a configuration through which the first particles 21a, the second particles 22a, the third particles 23a, and the adsorption agent do not pass but a liquid can pass. Specifically, the connecting portion 51 has a mesh structure. The connecting portion 51 having such a mesh structure can prevent the particles in the treatment layers from flowing out from the connecting portion 51. The nominal opening of the mesh of the connecting portion 51 has a size that can prevent the smallest particle among these from flowing out. The nominal opening can be appropriately designed in accordance with the types of particles.

The connecting portion 51 has wall portions 51 a in regions connected to the first gap layer 24, the second gap layer 25, and the header portion 11. The wall portions 51a prevent the cleaning fluid B from passing through the first gap layer 24, the second gap layer 25, and the header portion 11, in which particles and the like to be cleaned are not present, and being collected in the discharge tube 14, thus improving the cleaning efficiency. The wall portions 51a can also prevent the produced water X from bypassing the treatment layers and flowing in the header portion 11.

### (Advantages of Adsorption Tower Module Disposed in Lateral Direction)

According to the adsorption tower module 201, since the direction in which the produced water X flows (lateral direction) is different from the direction in which the jet water flow A flows (upward-downward direction), it is possible to prevent the cleaning fluid B after cleaning of a certain treatment layer, the cleaning fluid B containing suspended substances, from flowing in another treatment layer disposed on the downstream side or the upstream side. Accordingly, it is not necessary to provide, for example, a complicated tube arrangement for separately cleaning the treatment layers, and thus the configuration for cleaning treatment layers can be simplified. Therefore, the oil-water separation treatment system is easily designed, and the production cost of the oil-water separation treatment system can be reduced. In the adsorption tower module 201, cleaning need not be separately performed for the treatment layers, and thus the cleaning time of the treatment layers can be reduced.

### INDUSTRIAL APPLICABILITY

As described above, the oil-water separation treatment system and the oil-water separation treatment method of the present invention can efficiently treat an oil-water mixed liquid containing oil droplets and suspended substances that have various particle diameters in a saved space, and can be suitably used in production facilities such as a factory and an oilfield. Furthermore, the oil-water separation treatment system and the oil-water separation treatment method of the present invention can also be applied to a water treatment system that separates and removes suspended substances, impurities, or water-insoluble oil components from untreated raw water.

1. An oil-water separation treatment system that separates a water-insoluble oil component from an oil-water mixed liquid, the system comprising:
an adsorption tower unit including at least one adsorption tower module; and a filtration unit including at least one filtration membrane module in that order,
wherein the adsorption tower module includes a tubular main body disposed vertically or horizontally, and a plurality of treatment layers which are divided from each other along an axial direction of the main body and in which a plurality of particles are enclosed, and
the filtration membrane module includes a filtration tank, a plurality of hollow fiber membranes that are disposed in the filtration tank and held in a state of being arranged to extend in one direction, and a holding member that fixes both ends of the plural hollow fiber membranes.

2. The oil-water separation treatment system according to claim 1, wherein the adsorption tower module includes, from the upstream side, a first treatment layer in which a plurality of first particles are enclosed, and a second treatment layer in which a plurality of second particles having an average diameter smaller than that of the first particles are enclosed, and the average diameter of the second particles is smaller than the average diameter of the first particles.

3. The oil-water separation treatment system according to claim 2, wherein the average diameter of the first particles is 100 μm or more and 2,000 μm or less, and the average diameter of the second particles is 10 μm or more and 500 μm or less.

4. The oil-water separation treatment system according to claim 1, wherein the hollow fiber membranes each include a supporting layer containing polytetrafluoroethylene as a main component and a filtration layer disposed on a surface of the supporting layer and containing polytetrafluoroethylene as a main component.

5. The oil-water separation treatment system according to claim 1, wherein the oil-water mixed liquid is oilfield produced water.

6. The oil-water separation treatment system according to claim 1, comprising a control unit that cleans the adsorption tower module and the filtration membrane module.

7. The oil-water separation treatment system according to claim 1, wherein the filtration membrane module further includes a bubble supplier that supplies a bubble from below the hollow fiber membranes.

8. The oil-water separation treatment system according to claim 6, further comprising a movable body on which the adsorption tower unit, the filtration unit, and the control unit are placed.

9. The oil-water separation treatment system according to claim 1, further comprising a separator that separates an oil-water mixed liquid from a drilled fluid.

10. An oil-water separation treatment method for separating a water-insoluble oil component from an oil-water mixed liquid, the method comprising:
a step of performing an adsorption treatment of an oil-water mixed liquid, the step being performed by an adsorption tower unit including at least one adsorption tower module; and
a filtration treatment step performed by a filtration unit including at least one filtration membrane module
in that order,
wherein the adsorption tower module includes a tubular main body disposed vertically or horizontally, and a plurality of treatment layers which are divided from each other along an axial direction of the main body and in which a plurality of particles are enclosed, and
the filtration membrane module includes a filtration tank, a plurality of hollow fiber membranes that are disposed in the filtration tank and held in a state of being arranged to extend in one direction, and a holding member that fixes both ends of the plural hollow fiber membranes.

11. The oil-water separation treatment system according to claim 6, further comprising a separator that separates an oil-water mixed liquid from a drilled fluid.
